(19) United States
(12) Patent Application Publication
(10) Pub. No.: US 2012/0079722 A1
(43) Pub. Date: Apr. 5, 2012

(54) Six cutting edge featured utility knife blade

(76) Inventors: Elwood Dean Quimby, Derby, KS (US); Hubert J. Bung, Wichita, KS (US)

(21) Appl. No.: 13/199,206

(22) Filed: Aug. 23, 2011

Related U.S. Application Data
(60) Provisional application No. 61/402,536, filed on Sep. 1, 2010.

(51) Int. Cl. B26B 9/00; B26B 5/00

(52) U.S. Cl. 30/165; 30/353

(57) ABSTRACT

A tri pointed shaped utility blade that has a sharp edge around its outer periphery or said perimeter sides.

Each of the three perimeter sides is divided into two sections. This makes a total of six sections and this specific shape is arranged into six cutting edge lines.

Each of the sections contains a separate cutting edge. This special arrangement provides six individual cutting edges on one blade.

The blade can be placed into special utility knives six different ways into a defined location, thereby providing the user with six individual cutting edges.

### CROSS-REFERENCES TO RELATED APPLICATIONS

7,921,568

5,557,852

2,542,582

4,592,113

3,037,342

5,636,845

4,745,653

This application claims the benefit of provisional patent application Application No. 61/402,536, filed Sep. 1, 20010 by present inventors.

### BACKGROUND

1. Field

This application relates to utility knife blades, more particularly, to unconventional utility knife blades with six defined individual cutting edges that allow the user to have available on one blade, six individual cutting edges that will be used with special designed utility knives.

2. Prior Art

Conventional disposable utility blades are well known in the art. These blades along with their knives have many industrial as well as home uses, such as for opening boxes, cutting cord or cutting wall-board. Typical utility blades are encased in a plastic or metal handle in either a fixed or retractable position. When in use, the blade is positioned to extend outwardly from the handle, exposing the cutting edge and one of the cutting points of the blade.

Utility knife blades come in a variety of shapes depending upon the intended use. A conventional utility blade has a generally trapezoidal shape that includes a back edge, a cutting edge and two side edges. The trapezoidal shaped blades have two cutting edges or tips formed at the intersections between the side edges and the cutting edge. These sharp points or tips enable a user to puncture through a material which is desired to be cut, such as sealing tape or the cardboard box. Once the object has been punctured and penetrated, the user can slice open the material by dragging the knife along the surface of the material allowing the cutting edge to cut through the material.

Although trapezoidal shaped utility blades are widely used, they have only two usable cutting edges. They have the disadvantage that when the two edges get dull, the blade has to be replaced. The two edged blade therefore requires more frequent replacement after the two cutting edges are worn out.

Break-off style blade with a multitude of cutting edges are not well suited for many applications and there is a greater safety or injury risk due to potential snap-off during usage when side loads are applied.

There is a need for an improved utility knife blade that overcomes one or more of the above-described drawbacks and/or disadvantages of conventional prior art utility knife blades.

### SUMMARY

Accordingly, the object of the new invention is having six cutting edges on one blade. Another object is to have the same blade length with each of the six cutting edges when placed in a special utility knife.

The utility blade herein described has handles designed for use specifically for this blade. These knives are protected with provisional patent applications and in the prototype and working stages; 61/465,471 dated Mar. 21, 2011; 61/516,054 dated Mar. 29, 2011; 61/517,700 dated Apr. 25, 2011.

Other aspects and advantages of the present invention will become more readily apparent in view of the following detailed description and accompanying drawings.

### BRIEF DESCRIPTION OF DRAWINGS

FIG. 1 shows an isometric view of the triangular blade. Note: A single mounting hole in its center.

FIG. 2 shows front view of blade. Note: Blade depicting cutting edges 1, 2 and 3.

FIG. 3 end view of blade.

FIG. 4 is backside view of blade, blade depicting cutting edges 4, 5 and 6. The drawing has the hidden lines displayed.

FIG. 5 is an Isometric view of blade with multiple holes.

FIG. 6 is a front view of blade.

FIG. 7 is a end view of blade.

FIG. 8 is the back side of blade.

FIG. 9 shows blade prior to insertion into knife.

FIG. 10 shows blade partially inserted within the knife.

FIG. 11 shows Blade fully engaged within the knife.

FIG. 12 shows a blade retaining pin (100)

FIG. 13 shows Bottom view of knife with blade inserted and secured.

FIG. 14 cutting edge 1 shown exposed after assembled into knife.

FIG. 15 cutting edge 2 shown exposed after assembled into knife.

FIG. 16 cutting edge 3 shown exposed after assembled into knife.

FIG. 17 cutting edge 4 shown exposed after assembled into knife.

FIG. 18 cutting edge 5 shown exposed after assembled into knife.

FIG. 19 cutting edge 6 shown exposed after assembled into knife.

FIG. 20 shows isometric view of six angled blade.

FIG. 21 shows front view of the blade with cutting edge indicators 1, 2 and 3 depicted.

FIG. 22 shows an end view.

FIG. 23 shows front view of blade with cutting edge indicators 4, 5 and 6 depicted.

FIG. 24 shows the cutting edge detail.

### DRAWINGS—REFERENCE NUMERAL

32 Cutting Edge

34 Blade Number

36 Blade

38 Cutting Edge Indicator

40 Center Hole

42 Multiple Hole

44 Beveled edge surface

80 Front portion of knife handle.

82 Blade retaining area within knife body.

84 Blade Pin retaining hole.

86 Blade pocket.

88 Partial handle of knife.

100 Blade retaining bolt. It can be a pin, a toggle bolt, a bolt and wing nut, a winged bolt, or others.

### DETAILED DESCRIPTIONS

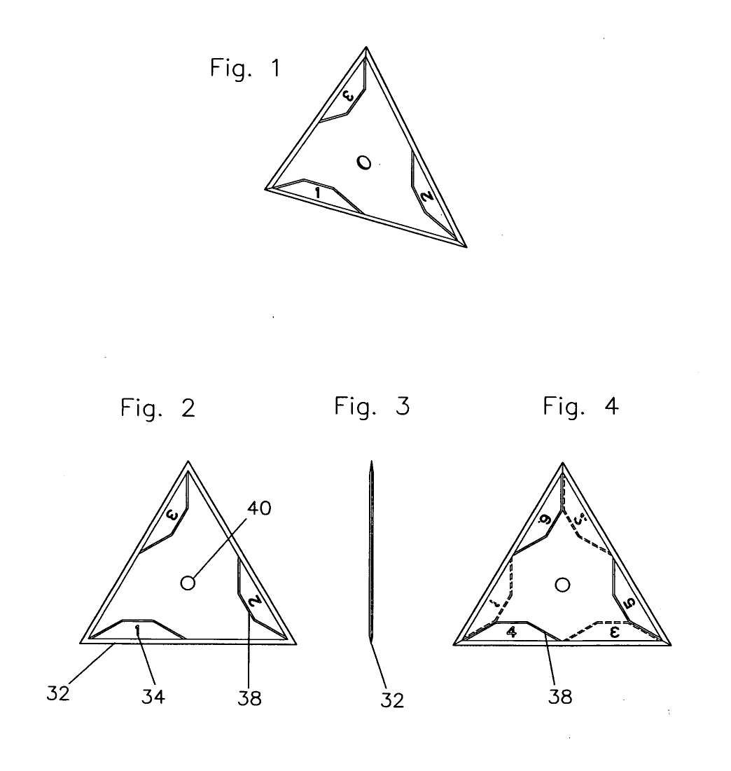

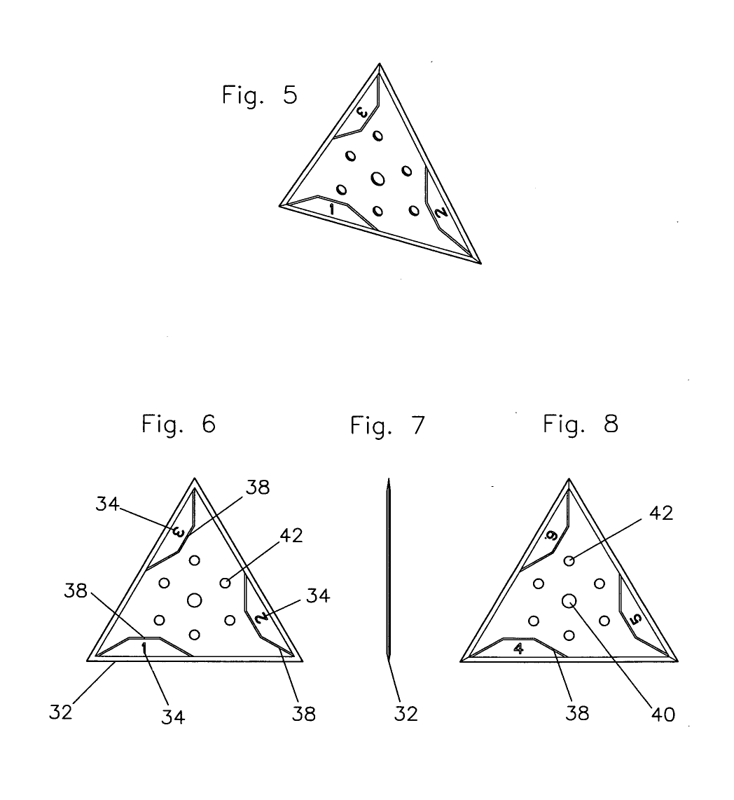

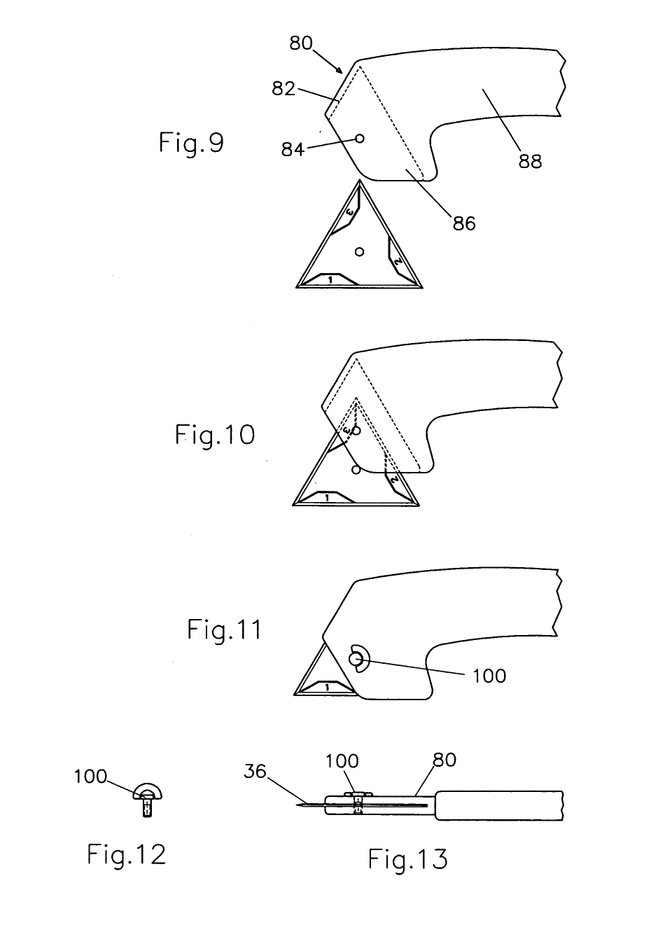

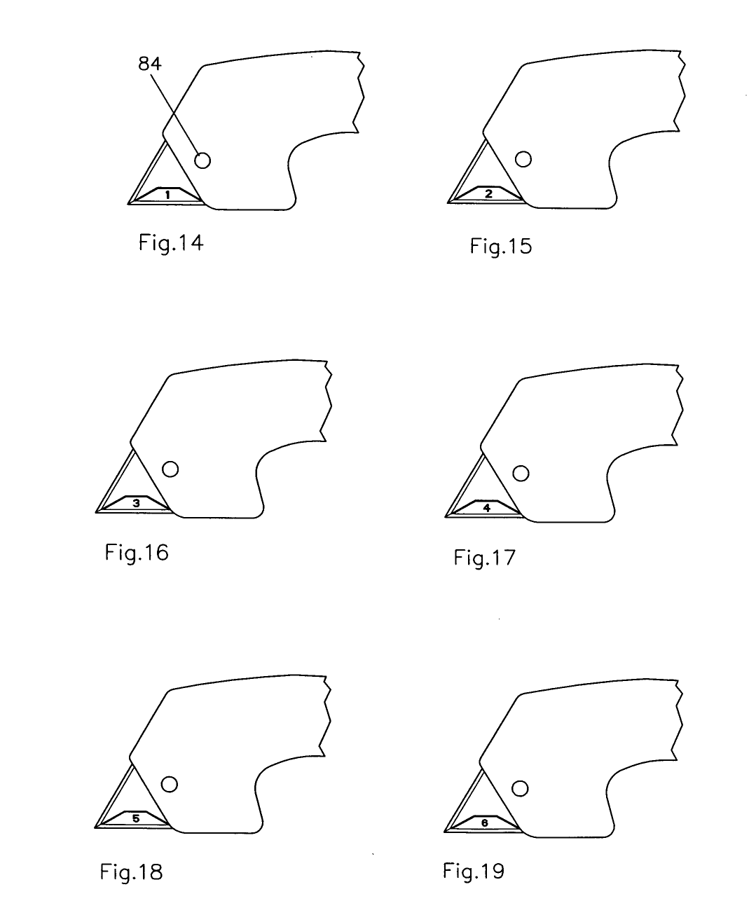

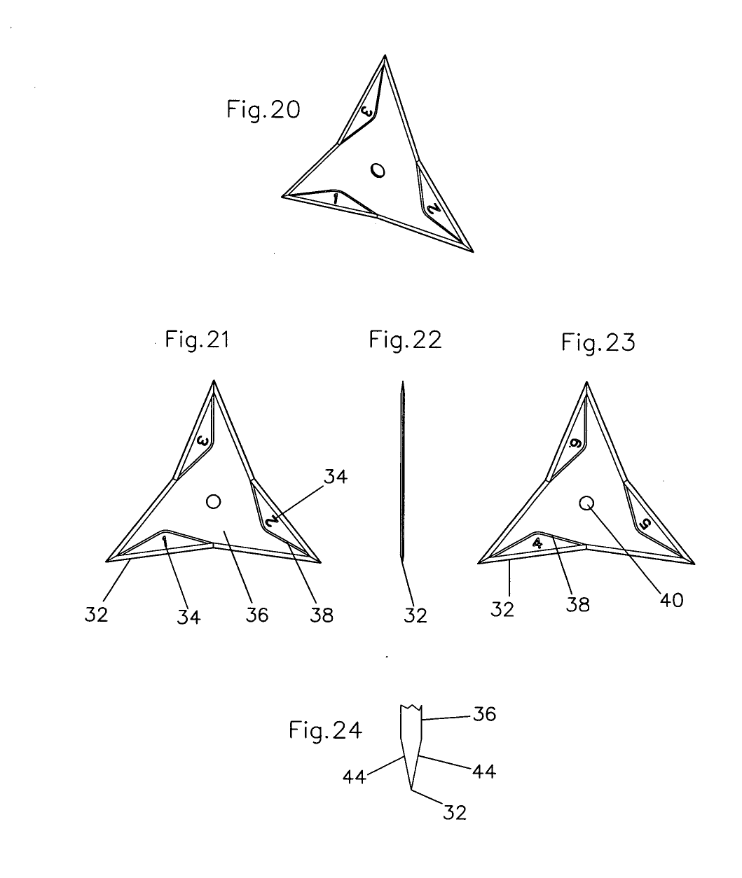

The blade is generally planer shaped. The blade herein described has an approximate triangular shape but it can be in a six angled form ref. FIG. 21. The extreme outer periphery is chamfered on each side (44). Its extreme outer portion generates the cutting edges. The blade herein described has six separate cutting edges, FIGS. 1, 2, 4, 5, 6 and 8. When the blade is properly installed in the knife, the cutting edge of number one will be ready for use, FIG. 14. When the cutting edge of number one becomes dull, rotate the blade to the number two cutting edge, FIG. 15. When the cutting edge number two becomes dull, rotate the blade to cutting edge number three, FIG. 16.

When the cutting edge of number three becomes dull, remove blade and flip it over. Place the blade in the knife to the number four cutting edge, FIG. 17. When the cutting surface of number four becomes dull, rotate the blade to the number five cutting edge, FIG. 18. When the cutting edge number five becomes dull, rotate the blade to the number six cutting edge, FIG. 19. When the cutting edge of number six becomes dull, replace the blade with a new blade. The aspects and advantages of the present invention will become more readily apparent after reviewing the drawings. The cutting edge numbers 1,2,3,4,5, and 6 can be etched into the surface or printed onto the blade 36, The cutting edge indicator can be etched, printed laser engraved or by other means identified on the blade.

The blade's cutting edge can be straight, serrated, wave shaped or can have micro serration's and other shapes as needed. The blade can be of different materials such as Steel alloys Bimetallic Tri-metallic, Ceramics and it can have different types of coatings to enhance its surface properties, hardness and to resist corrosion. The blade can be of different size and thickness. The blade can have multiple holes. The number of holes can be of more or less in quantities and be arranged in different patterns. The holes or openings can be of different sizes and shapes. The blade outmost tip is generally pointed but it also can be, rounded.

1. A six cutting edged featured utility blade, which provides six individual cutting edges on one blade.

2. A utility knife blade that will be arranged and located in a blade retainer in such a way that it provides 6 individually usable cutting edges.

3. A utility knife blade as defined comprising of six cutting edges, wherein each cutting area is spaced approximately the same distance from its respective midpoint/halfway point of side length or symmetrical centerline of triangle.

4. A utility knife blade as defined in combination with a utility knife, wherein a utility knife blade may or may not have blade numbers or alphabetical markings to identify the sequential usage of said cutting edge, therefore the embodiment can provide an usage indicating status of used/worn edges, if used in the intended and logical way and sequence. The typical logical and preferred blade change sequence is: 1, 2, 3, 4, 5, 6. or if lettering is preferred it is A, B, C, D, E, F.

5. A utility knife blade that may have different blade number markings or symbols or other indicators to identify the sequential usage of cutting edge.

7. A generally planar knife blade having an approximately triangular pointed shape with its cutting edge around its outer periphery.
